(19) United States
(12) Patent Application Publication
(10) Pub. No.: US 2026/0261939 A1
(43) Pub. Date: Sep. 3, 2026

(54) TRANSMITTER CAPABILITY REPORTING FOR AMBIENT INTERNET OF THINGS (IOT) DEVICES

(71) Applicant: QUALCOMM Incorporated, San Diego, CA (US)

(72) Inventors: Luanxia YANG, Beijing (CN); Xiaojie WANG, Hillsborough, NJ (US); Xiaoxia ZHANG, San Diego, CA (US); Junyi LI, Greentown, PA (US)

(21) Appl. No.: 19/155,537

(22) PCT Filed: Mar. 27, 2023
(86) PCT No.: PCT/CN2023/084064

§ 371 Date: Aug. 11, 2025

(51) Int. Cl. H04W 36/14

(52) U.S. Cl. CPC H04W 36/142

(57) ABSTRACT

A method for wireless communication by a wireless communication device includes transmitting, to a network node, a capability report indicating a group of ambient transmission modes supported by the wireless communication device and one or more ambient transmission parameters. The method also includes switching from a current ambient transmission mode, of the group of ambient transmission modes, to a second ambient transmission mode, of the group of ambient transmission modes, based on satisfying a first switching condition of a group of switching conditions associated with switching from the current ambient transmission mode to the second ambient transmission mode. The method further includes communicating with the network node according to the second ambient transmission mode in accordance with switching to the second ambient transmission mode.

### FIELD OF THE DISCLOSURE

The present disclosure relates generally to wireless communications, and more specifically to transmitter capability reporting for ambient Internet of Things (IoT) devices.

### BACKGROUND

Wireless communication systems are widely deployed to provide various telecommunications services such as telephony, video, data, messaging, and broadcasts. Typical wireless communication systems may employ multiple-access technologies capable of supporting communications with multiple users by sharing available system resources (for example, bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (for example also known as discrete Fourier transform spread OFDM (DFT-s-OFDM)) on the uplink (UL), as well as supporting beamforming, multiple-input multiple-output (MIMO) antenna technology, and carrier aggregation.

Some wireless communication systems, such as some Internet of Things (IoT) systems, may use ambient IoT devices. An ambient IoT device is an example of a wireless communication device that may monitor an environment and/or control various aspects of the environment. In some examples, an ambient IoT device may include one or more sensors and may be connected to the Internet to enable real-time data processing and communication with other devices. Examples of ambient IoT devices include smart thermostats, smart lighting systems, and smart speakers. A radio frequency identification (RFID) device may be an example of an ambient IoT device. Ambient IoT devices may support one or more ambient transmission modes, such as an active transmission mode, a passive backscattering mode, or an amplified backscattering mode.

### SUMMARY

In some aspects, a method for wireless communication by a wireless communication device is presented. The method includes transmitting a capability report indicating a group of ambient transmission modes supported by the wireless communication device and one or more ambient transmission parameters to a network node. Additionally, the method includes switching from a current ambient transmission mode, of the group of ambient transmission modes, to a second ambient transmission mode within the group of ambient transmission modes. The wireless communication device may switch to the second ambient transmission mode based on satisfying a first switching condition out of a group of switching conditions associated with the process of switching from the current ambient transmission mode to the second ambient transmission mode. Finally, the method includes communicating with the network node according to the second ambient transmission mode in accordance with the process of switching to the second ambient transmission mode.

In some aspects, a non-transitory computer-readable medium includes program code for wireless communication at a wireless communication device. The program code is executed by a processor and includes program code to transmit a capability report indicating a group of ambient transmission modes supported by the wireless communication device and one or more ambient transmission parameters to a network node. Additionally, the program code includes program code to switch from a current ambient transmission mode, of the group of ambient transmission modes, to a second ambient transmission mode within the group of ambient transmission modes. The switching is based on satisfying a first switching condition out of a group of switching conditions associated with the process of switching from the current ambient transmission mode to the second ambient transmission mode. Finally, the program code includes program code to communicate with the network node according to the second ambient transmission mode in accordance with the process of switching to the second ambient transmission mode.

In some aspects, an apparatus for wireless communication at a wireless communication device is presented. The apparatus includes a processor and a memory coupled with the processor. The memory stores instructions that are operable, when executed by the processor, to cause the apparatus to transmit a capability report to a network node. The capability report indicates a group of ambient transmission modes supported by the wireless communication device and one or more ambient transmission parameters. Execution of the instructions also cause the apparatus to switch from a current ambient transmission mode, which is part of the group of ambient transmission modes, to a second ambient transmission mode within the same group. The wireless communication device may switch to the second ambient transmission mode based on satisfying a first switching condition out of a group of switching conditions associated with the process of switching from the current ambient transmission mode to the second ambient transmission mode. Finally, execution of the instructions also cause the apparatus to communicate with the network node according to the second ambient transmission mode in accordance with the process of switching to the second ambient transmission mode.

In some aspects, an apparatus for wireless communication at a wireless communication device is presented. The apparatus includes means for transmitting a capability report indicating a group of ambient transmission modes supported by the wireless communication device and one or more ambient transmission parameters to a network node. Additionally, the apparatus includes means for switching from a current ambient transmission mode, of the group of ambient transmission modes, to a second ambient transmission mode within the group of ambient transmission modes. The wireless communication device may switch to the second ambient transmission mode based on satisfying a first switching condition out of a group of switching conditions associated with the process of switching from the current ambient transmission mode to the second ambient transmission mode. Finally, the apparatus includes means for communicating with the network node according to the second ambient transmission mode in accordance with the process of switching to the second ambient transmission mode.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is block diagram illustrating an example ambient Internet of Things (IoT) system, in accordance with various aspects of the present disclosure.

FIG. 5 illustrates an example of a backscattering device, in accordance with various aspects of the present disclosure.

FIG. 6 is a block diagram illustrating an example of a power amplifier, in accordance with various aspects of the present disclosure.

FIG. 7 is a block diagram illustrating an example of switching durations associated with a group of ambient transmission modes supported by an ambient IoT device, in accordance with various aspects of the present disclosure.

FIG. 8 is a block diagram illustrating an example wireless communication device that supports multiple ambient transmission modes, in accordance with some aspects of the present disclosure.

FIG. 9 is a flow diagram illustrating an example process of indicating one or more ambient transmission parameters performed, for example, by an ambient IoT device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G, 4G, and/or 6G technologies.

Some wireless communication systems, such as some Internet of Things (IoT) systems, may use ambient IoT devices. An ambient IoT device is an example of a wireless communication device (hereinafter used interchangeably with “ambient IoT device”) that may monitor an environment and/or control various aspects of the environment. Examples of ambient IoT devices include smart thermostats, smart lighting systems, and smart speakers. A radio frequency identification (RFID) device may be an example of an ambient IoT device. Ambient IoT devices may support one or more ambient transmission modes, such as an active transmission mode, a passive backscatter mode, or an amplified backscatter mode.

In the active transmission mode, the ambient IoT device uses its own power source, such as a battery, to actively transmit signals to another device, such as a network node. The network node may be an example of an RFID reader. In the passive backscattering mode, the ambient IoT device uses energy from a signal (for example, a radio frequency (RF) signal) transmitted by a network node to power up and respond to the signal transmitted from the network node. In the amplified backscattering mode, the ambient IoT device uses an amplifier to amplify the signal received from the network node before reflecting a portion of the signal back to the network node. This amplification may increase a strength of the signal and improve the communication range between the ambient IoT device and the network node (for example, the RFID reader). Each one of the ambient transmission modes may be associated with one or more respective ambient transmission parameters, such as a transmission power, a scheduling function, or a modulation format. In some examples, the scheduling function may be based on an uplink transmission capability of the respective ambient IoT device.

Supported ambient transmission modes may vary from one ambient IoT device to another. For instance, while some ambient IoT devices may only support a passive backscatter mode and an active transmission mode, others may only support a passive backscatter mode and an amplified backscatter mode. Conventional ambient IoT devices do not indicate their supported ambient transmission modes and one or more ambient transmission parameters to a network device. As a result, the network node may use one or more unsupported ambient transmission parameters when communicating with an ambient IoT device because the network node may be unaware of the one or more ambient transmission parameters associated with a current ambient transmission mode of the ambient IoT device. For example, the network node may communicate with the ambient IoT device using one or more of a transmission power, scheduling function, modulation format, and/or frequency shift that is not supported by the current ambient transmission mode used by the ambient IoT device. This lack of support may lead to communication errors, such as decoding errors and/or synchronization errors, between the network node and the ambient IoT device.

Various aspects of the present disclosure generally relate to an ambient IoT device indicating, to a network node, one or more ambient transmission modes supported by the ambient IoT device and one or more ambient transmission parameters. In some examples, the ambient IoT device transmits, to the network node, a capability report indicating the one or more ambient transmission modes supported by the wireless communication device and one or more ambient transmission parameters. In such examples, the one or more ambient transmission parameters may include a group of switching durations, a group of switching factors, a continuous transmission parameter, one or more supported modulation formats, a local clock parameter, and/or a frequency shift parameter. In some examples, the ambient IoT device may switch from a current ambient transmission mode, of the group of ambient transmission modes, to a second transmission mode, of the group of ambient transmission modes. The switching may be based on satisfying a first switching condition of a group of switching conditions associated with switching from the current ambient transmission mode to the second ambient transmission mode. Each switching condition of the group of switching conditions may be associated with a respective condition for switching from one ambient transmission mode, of the group of ambient transmission modes, to another ambient transmission mode, of the group of ambient transmission modes. For example, the first switching condition may be satisfied based on an energy level at the ambient IoT device being greater than a first energy threshold, the energy level at the ambient IoT device being less than a second energy threshold, or the ambient IoT device receiving, from the network node, a switching indication.

Particular aspects of the subject matter described in this disclosure can be implemented to realize one or more of the following potential advantages. In some examples, the described techniques, such as the ambient IoT device transmitting, to the network node, a capability report indicating one or more ambient transmission modes supported by the ambient IoT device and one or more ambient transmission parameters, may allow the network node to use ambient transmission parameters supported by a current ambient transmission mode of the ambient IoT device. The use of ambient transmission parameters supported by the current ambient transmission mode of the ambient IoT device may reduce decoding errors and/or synchronization errors, thereby improving overall network reliability.

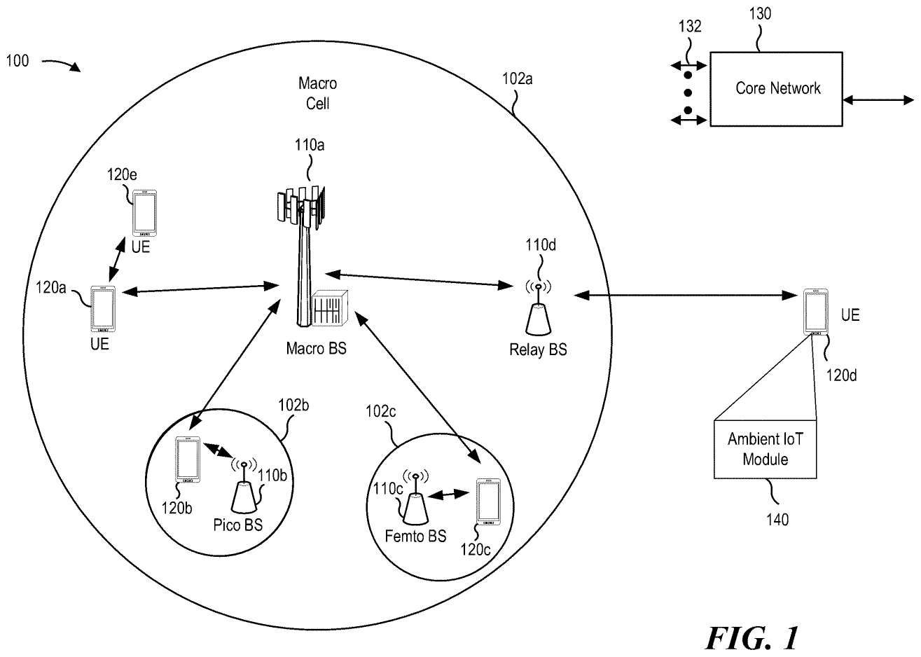

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (for example several kilometers in radius) and may allow unrestricted access by UEs with service subscription. A pico cell may cover a relatively small geographic area and may allow unrestricted access by UEs with service subscription. A femto cell may cover a relatively small geographic area (for example a home) and may allow restricted access by UEs having association with the femto cell (for example UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (for example three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (for example a BS or a UE) and send a transmission of the data to a downstream station (for example a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (for example, macro BSs, pico BSs, femto BSs, relay BSs, and/or the like). These different types of BSs may have different transmit power levels, different coverage areas, and different impact on interference in the wireless network 100. For example, macro BSs may have a high transmit power level (for example 5 to 40 watts) whereas pico BSs, femto BSs, and relay BSs may have lower transmit power levels (for example 0.1 to 2 watts).

As an example, the BSs 110 (shown as BS 110a, BS 110b, BS 110c, and BS 110d) and the core network 130 may exchange communications via backhaul links 132 (for example S1, etc.). Base stations 110 may communicate with one another over other backhaul links (for example X2, etc.) either directly or indirectly (for example through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (for example S1, S2, etc.) and may perform radio configuration and scheduling for communications with the UEs 120. In some configurations, various functions of each access network entity or base station 110 may be distributed across various network devices (for example radio heads and access network controllers) or consolidated into a single network device (for example a base station 110).

UEs 120 (for example 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example smart ring, smart bracelet)), an entertainment device (for example a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

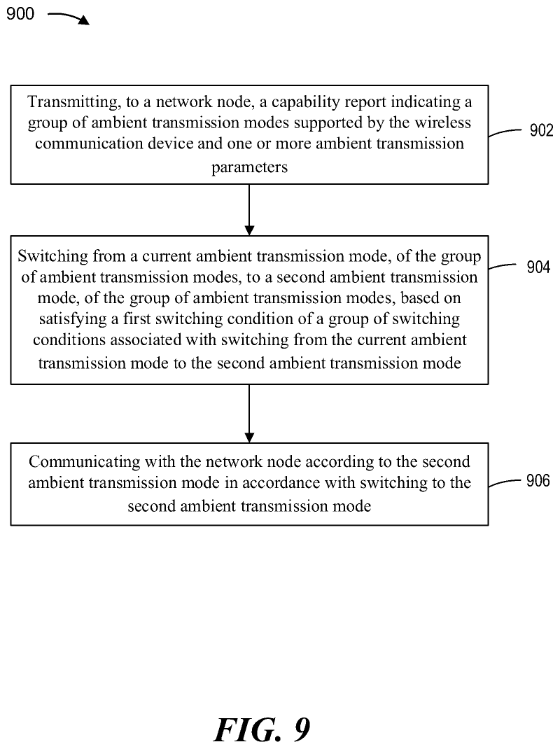

The UEs 120 may include an ambient IoT module 140. For brevity, only one UE 120d is shown as including the ambient IoT module 140. The ambient IoT module 140 may perform one or more elements of the process 900 described with reference to FIG. 9.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet of things (IoT) devices, and/or may be implemented as NB-IoT (narrowband Internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (for example, shown as UE 120a and UE 120e) may communicate directly using one or more sidelink channels (for example without using a base station 110 as an intermediary to communicate with one another). For example, the UEs 120 may communicate using peer-to-peer (P2P) communications, device-to-device (D2D) communications, a vehicle-to-everything (V2X) protocol (for example which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (for example, a system information block (SIB).

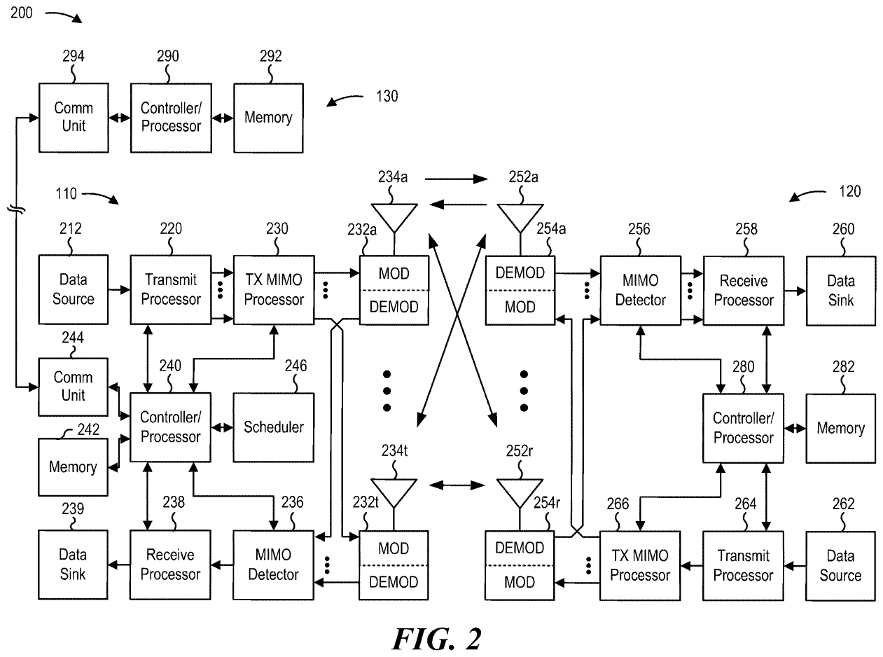

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (for example encode and modulate) the data for each UE based at least in part on the MCS(s) selected for the UE, and provide data symbols for all UEs. Decreasing the MCS lowers throughput but increases reliability of the transmission. The transmit processor 220 may also process system information (for example for semi-static resource partitioning information (SRPI) and/or the like) and control information (for example, CQI requests, grants, upper layer signaling, and/or the like) and provide overhead symbols and control symbols. The transmit processor 220 may also generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, and/or the reference symbols, if applicable, and may provide T output symbol streams to T modulators (MODs) 232a through 232t. Each modulator 232 may process a respective output symbol stream (for example, for orthogonal frequency division multiplexing (OFDM) and/or the like) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (for example, for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (for example for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with transmitting a capability report and communicating in accordance with a supported ambient transmission mode and one or more ambient transmission parameters as described in more detail elsewhere. For example, the controller/processor 240 of the base station 110, the controller/processor 280 of the UE 120, and/or any other component(s) of FIG. 2 may perform or direct operations of, for example, the process 900 of FIG. 9 and/or other processes as described. Memories 242 and 282 may store data and program codes for the base station 110 and UE 120, respectively. A scheduler 246 may schedule UEs for data transmission on the downlink and/or uplink.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (for example, a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

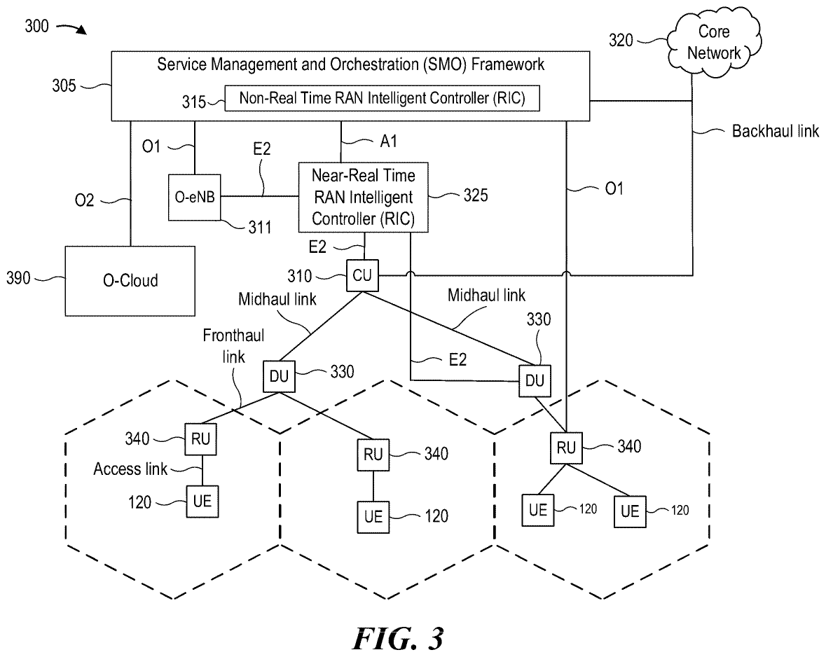

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (for example, the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (for example, central unit-user plane (CU-UP)), control plane functionality (for example, central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via 01) or via creation of RAN management policies (such as A1 policies).

In some wireless communication systems, such as IoT systems, low-cost and low-complexity wireless devices may be used to provide wireless connectivity to a wide range of devices. An ambient IoT device is an example of a relatively low-cost and relatively low-complexity device that may be used to provide wireless connectivity to a wide range of devices. A radio frequency identification (RFID) device may be an example of an ambient IoT device. RFID devices have become increasingly popular in numerous industries due to their economic potential for various applications, such as inventory and asset management within and outside of warehouses, IoT devices, sustainable sensor networks, and smart home implementations. In the present application, an RFID device refers to a wireless communication device that uses an RFID component, such as an RFID transponder (for example, a tag), that emits an information-bearing signal upon receiving a signal from an RFID reader (for example, a network node).

In some cases, the RFID device may include an RFID component in addition to one or more RF components that enable other types of wireless communications (for example, 5G or new radio (NR) communications, 6G communications, WI-FI communications, and/or device-to-device communications). In some other cases, the RFID device may not be capable of other types of wireless communications and may rely only on RFID type communications. The RFID device may be a relatively low-power device. In some examples, the RFID device may use backscatter modulation, which allows for larger distances between devices, or inductive coupling for more near-field communications. In systems that use backscatter modulation, an interrogation signal from an interrogating device (for example, a network node or network device such as a remote radio head (RRH)) is reflected back to the interrogating device with information modulated on the reflected signal. In some cases, the RFID device may be operated without a battery at low operational expenditures, low maintenance cost, and with a long lifespan. A passive RFID device is an example of a device that is capable of harvesting energy over-the-air and powering a transceiver. Additionally, a semi-passive RFID device and an active RFID device are examples of devices that may use a power source, such as a battery.

With the expansion of wireless communication systems, such as 5G NR, to various industrial verticals, such as ultra-reliable low latency communication (URLLC) and machine type communication (MTC), such wireless communication systems may be specified to support ambient IoT in addition to enhanced mobile broadband (eMBB). Ambient IoT refers to the integration of IoT devices into an environment in a non-intrusive and subtle manner. In most cases, ambient IoT devices may be small, low-power sensors that may operate without any user intervention, which is in contrast to conventional IoT devices.

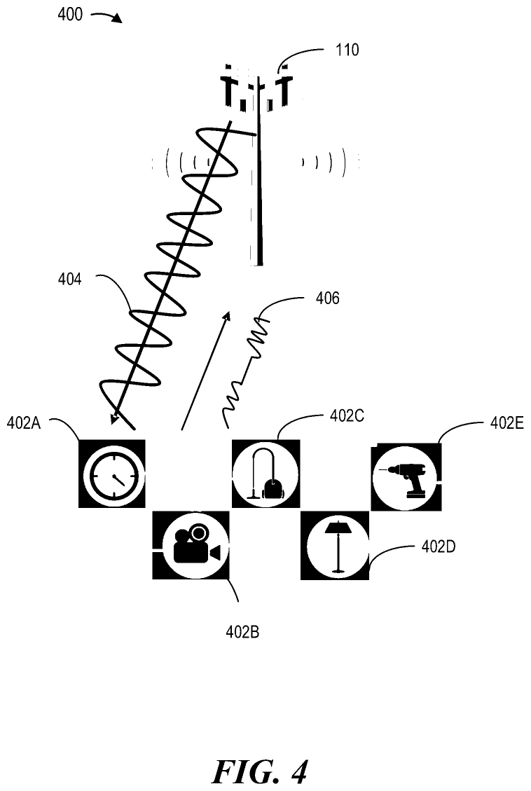

FIG. 4 is a block diagram illustrating an example ambient IoT system 400, in accordance with various aspects of the present disclosure. As shown in the example of FIG. 4, a network node 420 may communicate with a group of ambient IoT devices 402A, 402B, 402C, 402D, and 402E. The network node 420 may be an example of an RFID reader. In some examples, the network node 420 may be an example of a base station 110 or a UE 120 described with reference to FIGS. 1, 2, and 3, a CU 310, DU 330, or RU 340 as described with reference to FIG. 3, an integrated access and backhaul (IAB) node, or an IAB repeater. Alternatively, the network node 420 Each of the ambient IoT devices 402A, 402B, 402C, 402D, and 402E may include one or more sensors for collecting data, such as temperature, humidity, and/or light levels, from a local environment. An RFID device is an example of an ambient IoT device. However, the ambient IoT devices 402A, 402B, 402C, 402D, and 402E are not limited to RFID devices. Other types of devices, such as temperature sensors, motion sensors, light sensors, personal electronics, and home lighting devices, may be examples of ambient IoT devices. In some examples, one or more of the ambient IoT devices 402A, 402B, 402C, 402D, and 402E may be a UE 120 described with reference to FIGS. 1, 2, and 3. In the example of FIG. 4, the first ambient IoT device 402A is a clock, the second ambient IoT device 402B is a video recording device, the third ambient IoT device 402C is a vacuum, the fourth ambient IoT device 402D is a floor lamp, and the fifth ambient IoT device 402E is a drill.

The ambient IoT devices 402A, 402B, 402C, 402D, and 402E may receive a first signal 404 from the network node 420 and transmit a second signal 406 to the network node 420, based on receiving the first signal 404. For ease of explanation, FIG. 4 only shows the first ambient IoT device 402A receiving the first signal 404 and transmitting the second signal 406. The second signal 406 may be transmitted in accordance with a current ambient transmission mode of the first ambient IoT device 402A. The current ambient transmission mode may be one of a group of ambient transmission modes supported by the first ambient IoT device 402A. The group of ambient transmission modes may include two or more of an active transmission mode, a passive backscatter mode, or an amplified backscatter mode. In the active transmission mode, the first ambient IoT device 402A uses its own power source, such as a battery, to actively transmit the second signal 406 to the network node 420. In the passive backscatter mode, the first ambient IoT device 402A uses energy from the first signal 404 transmitted by the network node 420 to power up and respond to the first signal 404. In the amplified backscatter mode, the first ambient IoT device 402A uses an amplifier to amplify the signal 404 received from the network node 420 before reflecting a portion of the first signal 404 back to the network node. The second signal 406 is an example of a reflected portion of the first signal 404. This amplification may increase a strength of the first signal 404 and improve the communication range between the first ambient IoT device 402A and the network node 420.

The 3GPP standards include specifications for supporting MTC/narrowband (NB)-IoT and reduced capability (RedCap) for MTC use cases. Still, some conventional wireless communication systems fail to communicate efficiently with some IoT devices, such as ambient IoT devices or passive IoT devices. This limitation hampers the potential use of IoT devices in asset management, logistics, warehousing, and manufacturing. Therefore, wireless communication systems, such as 6G and beyond, may be specified to manage ambient IoT devices. In such wireless communication systems, a network node, such as a next generation NodeB, may be specified to read from and write to ambient IoT devices, and also provide energy to the ambient IoT devices. In some examples, an ambient IoT device may reflect information-bearing signals to the network node, and the network node may read the reflected signal to decode the information transmitted by the ambient IoT device.

Aspects of the present disclosure are not limited to the ambient IoT device communicating with a network node. Other devices, such as a UE, an IAB node, or an IAB repeater may communicate (for example, read from and write to) ambient IoT devices. An IAB node or repeater is an examples of a device, in a wireless network, that provide wireless coverage and also acts as a relay point to extend the network coverage area. In some examples, the IAB node/repeater provides both access to the network for end-users and also backhaul connectivity to the core network. The LAB technology may be used in both macro and small cell deployments to enhance network coverage and capacity.

In some examples, an ambient IoT device may be powered by a power source, such as a battery. In some other examples, the ambient IoT device may be powered by wireless power transfer (WPT) technology. In such examples, WPT technology may provide power to electronic devices without a conventional power supply, such as a battery. WPT-enabled wireless networks may power devices such as smartphones, wearables, and other IoT devices, as well as larger devices such as laptops and electric vehicles. In a WPT-enabled wireless network, power is transmitted through the air from a power source, such as a charging pad or transmitter, to a receiver that is built into the device to be powered. WPT technology relies on the principles of electromagnetic induction or magnetic resonance, and the power is transferred through an oscillating magnetic field. Additionally, WPT technology may also power an RFID device. In such cases, energy harvesting circuitry may harvest energy from the signals transmitted by the network node to charge a power supply, such as a battery. An RFID device that uses WPT technology for power may be referred to as a WPT-enabled active RFID device. WPT-enabled active RFID devices may have a further range than passive RFID devices. WPT-enabled devices may not require a manual battery replacement and may have a longer lifespan than devices that are not WPT-enabled. In a WPT system, a duration for energy gathering may be greater than a duration for information transfer.

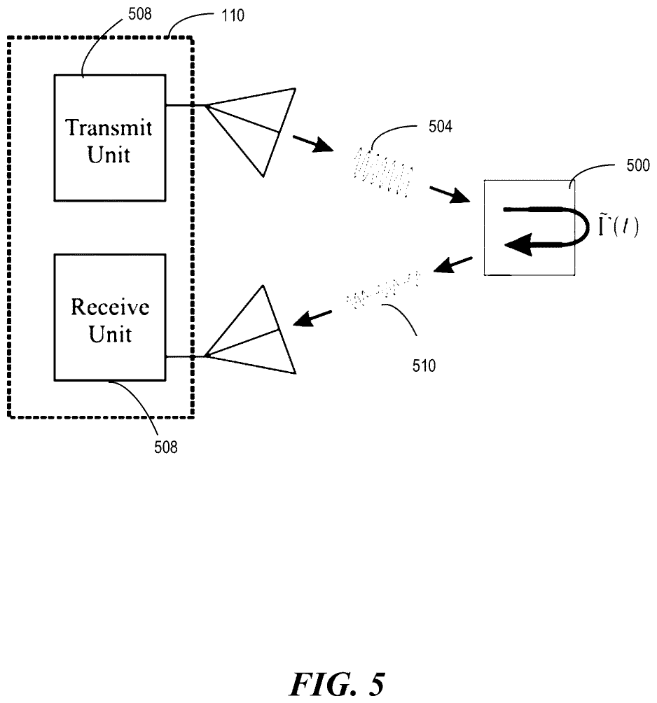

As discussed, an ambient IoT device, such as an RFID device, may communicate via a passive or an amplified backscatter mode. Both the passive and amplified backscatter modes use backscattering modulation, where mismatched loads are used to reflect the RF signal back to a transmitter with amplitude or phase modulation. FIG. 5 illustrates an example of a backscattering device 500, in accordance with various aspects of the present disclosure. The backscattering device 500 may be used by a transmitting device, such as an ambient IoT device 402A, 402B, 402C, 402D, or 402E described with reference to FIG. 4 or a UE 120 described with reference to FIGS. 1, 2, and 3, that may receive an incoming signal 504 and transmit a backscattered signal 510 using backscatter modulation.

In this example, an antenna (not shown) integrated with the backscattering device 500 may receive the incoming signal 504, transmitted from a transmit unit 506 of a network node 110, that is provided to an RF switch (not shown) of the backscattering device 500. A controller (not shown in the example of FIG. 5) may switch the incoming signal 504 between different impedances, to generate a reflection that is output through the antenna as a backscattered signal 510. In this example, switching between different impedances may be performed to modulate the incoming signal 504 according to amplitude shift keying (ASK) or phase shift keying (PSK). Different impedances may indicate different symbols, which may be demodulated to obtain information bits.

For example, load modulation may provide changing impedance Zᵢ to adjust a reflection coefficient for absorbing or reflecting the impinging electromagnetic wave (for example, incoming signal 504) according to Γᵢ=Zᵢ−Zₐ*/Zᵢ+Zₐ where Zₐ represents an intrinsic impedance of the antenna. For example, Zᵢ may have two or more states for absorbing or reflecting the wave. In some cases, the controller may control the RF switch to provide ASK and/or PSK by switching the impendences. In some cases, the incoming signal 504 and backscattered signal 510 may operate in frequency bands at 902-928 MHz, 2400-2483.5 MHz, and/or 5725-5850 MHz.

In some cases, backscattered communications may provide full-duplex communications at the network node 110, or other reader, that transmits the incoming signal 504 at the transmit unit 506 and receives the backscattered signal 510 at a receive unit 508. In the example of FIG. 5, the backscattered signal 510 may be in the same band or carrier as the incoming signal 504, and reader-side detection of the backscattered signal 510 may suffer from full-duplex interference. In some cases, such interference may be mitigated through backscatter with frequency shift.

As discussed, supported ambient transmission modes may vary from one ambient IoT device to another. For instance, while some ambient IoT devices may only support a passive backscatter mode and an active transmission mode, others may only support a passive backscatter mode and an amplified backscatter mode. Conventional ambient IoT devices do not indicate their supported ambient transmission modes to a network device. As a result, the network node may not support one or both of a transmission power or a scheduling function associated with an ambient transmission mode utilized by an ambient IoT device communicating with the network node. This lack of support may lead to communication failures between the network node and the ambient IoT device. To mitigate communication failures, various aspects of the present disclosure are directed to an ambient device transmitting a capability report to the network node. The capability report may indicate one or more ambient transmission modes supported by the ambient IoT device and one or more ambient transmission parameters.

In some examples, an ambient IoT device may only support an active signal mode. In such examples, the ambient IoT device may indicate, via the capability report, a maximum supported transmission power. The maximum supported transmission power may vary based on the ambient IoT device's energy status. The different supported transmission power levels correspond to varying energy levels. Table 1 shows supported transmission powers P1, P2, . . . , PN and the related energy statuses E1, E2, . . . , EN.

TABLE 1

| Supported Transmission Power | Energy Status |
|---|---|
| P₁ | >E₁ |
| P₂ | >E₂ |
| . | . |
| . | . |
| . | . |
| P_{N} | >E_{N} |

In some examples, the capability report may also indicate an available time duration for each supported transmission power. The available time duration indicates an amount of time the ambient IoT device may transmit at a given transmission power. For example, the ambient IoT device may transmit, at a first supported transmission power P1, for a first time duration T1. Table 2 shows supported transmission powers P1, P2, . . . , PN and the related supported transmission durations T1, T2, . . . , TN.

TABLE 2

| Supported Transmission Power | Supported Transmission Duration |
|---|---|
| P₁ | T₁ |
| P₂ | T₂ |
| . | . |
| . | . |
| . | . |
| P_{N} | T_{N} |

In some other examples, an ambient IoT device may only support a passive backscatter mode. In yet other examples, an ambient IoT device may only support an amplified backscatter mode. In such examples, the ambient IoT device may indicate, to the network node via the capability report, that the transmissions are power amplified. Additionally, the capability report may indicate an amplification level. The amplification level may be a fixed level and a tunable level. In some examples, the capability report may indicate a maximum and a minimum amplification level. In some such examples, the capability report may further indicate granularities of the amplification level. The amplification level granularity refers to a minimum amount by which a signal may be amplified.

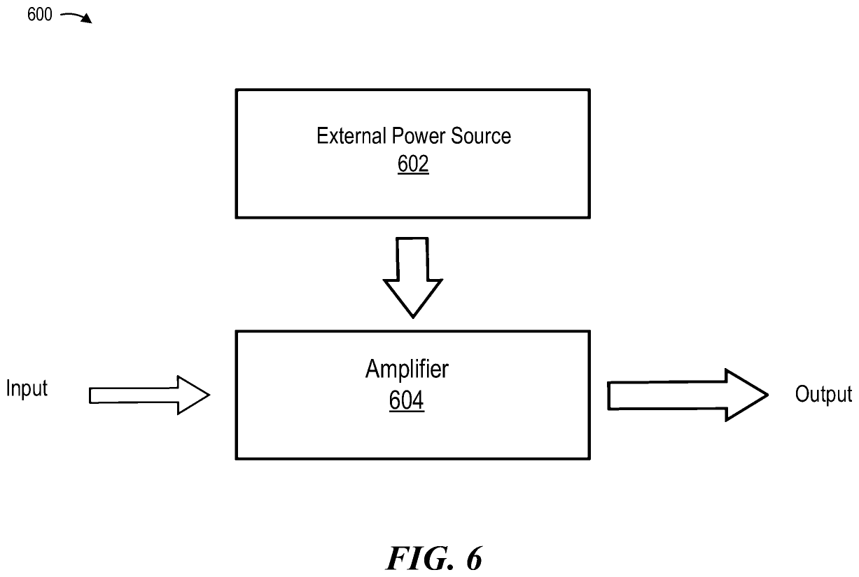

FIG. 6 is block diagram illustrating an example of a power amplifier 600, in accordance with various aspects of the present disclosure. In the example of FIG. 6, an external power source 602 may provide power to an amplifier 604. The external power source 602 may be a battery or another type of power source. In wireless communication, signal strength can degrade as a signal travels through the air. The power amplifier 600 may compensate for this loss by increasing a signal strength. As shown in the example of FIG. 6, an output of the amplifier 604 is an amplified version of an input signal. The power amplifier 600 may be designed using different types of technologies, such as bipolar transistors, field-effect transistors (FETs), or integrated circuits (ICs). The choice of technology depends on the requirements of the application, such as the desired frequency range, power output, efficiency, and cost.

In some examples, an ambient IoT device may support any combination of the active transmission mode, the passive backscatter mode, and the amplified backscatter mode. In one example, the ambient IoT device supports both the active transmission mode and passive backscatter mode. In another example, the ambient IoT device supports both the active transmission mode and the amplified backscatter mode. In yet another example, the ambient IoT device may support both the passive backscatter mode and the amplified backscatter mode. In still another example, the ambient IoT device may support the passive backscatter mode, the amplified backscatter mode, and the active transmission mode.

The ambient IoT device may switch from one ambient transmission mode to another ambient transmission mode. In some examples, a switching duration may be specified for switching from a first ambient transmission mode to a second ambient transmission mode. The switching duration refers to an amount of time specified to switch from the first ambient transmission mode to the second ambient transmission mode. In some other examples, the ambient IoT device supports an immediate switch from one ambient transmission mode to another ambient transmission mode. In such examples, the switching duration may be a zero value.

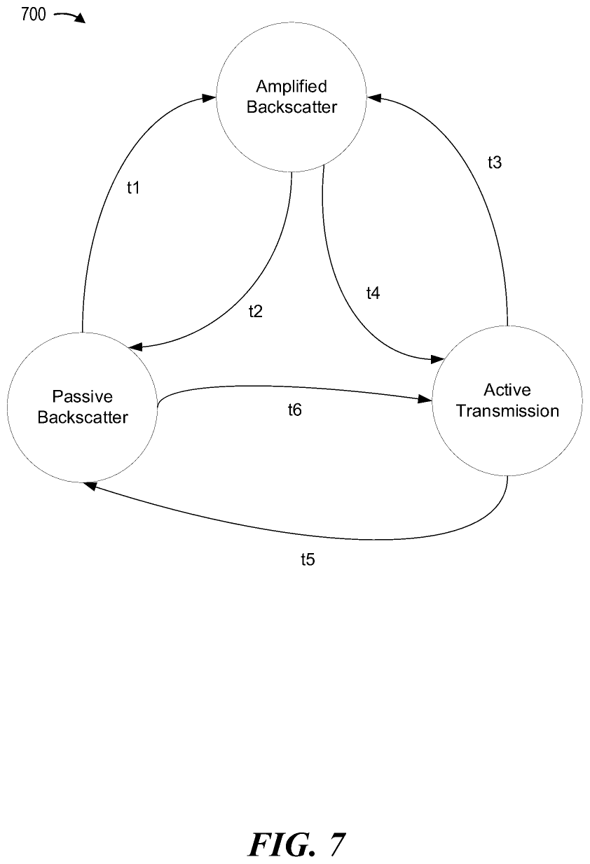

FIG. 7 is a block diagram illustrating an example 700 of switching durations associated with a group of ambient transmission modes supported by an ambient IoT device, in accordance with various aspects of the present disclosure. In the example of FIG. 7, an ambient IoT device, such as an ambient IoT device 402A, 402B, 402C, 402D, or 402E described with reference to FIG. 4, may support a group of ambient transmission modes. For ease of explanation, in the example 700 of FIG. 7, the ambient IoT device may support a passive backscatter mode, an amplified backscatter mode, and an active transmission mode. The ambient IoT device is not limited to supporting the passive backscatter mode, the amplified backscatter mode, and the active transmission mode. As discussed, the ambient IoT device may support any combination of the passive backscatter mode, the amplified backscatter mode, and the active transmission mode. As discussed, a switching duration may be specified for switching from a first ambient transmission mode to a second ambient transmission mode. In the example of FIG. 7, t1 is a switching duration for switching from the passive backscatter mode to the amplified backscatter mode, t2 is a switching duration for switching from the amplified backscatter mode to the passive backscatter mode, t3 is a switching duration for switching from the active transmission mode to the amplified backscatter mode, t4 is a switching duration for switching from the amplified backscatter mode to the active transmission mode, t5 is a switching duration for switching from the active transmission mode to the passive backscatter mode, and t6 is a switching duration for switching from the passive backscatter mode to the active transmission mode.

In some examples, an amount of time for each switching duration may be indicated, to a network node, via the one or more ambient transmission parameters included in a capability report. In some such examples, the capability report may indicate a group of switching durations. Each switching duration may be associated with a respective switch from one ambient transmission mode to another ambient transmission mode. In some examples, each ambient transmission mode of the group of ambient transmission modes supported by the ambient IoT device may be associated with the same switching duration. In such examples, t1, t2, t3, t4, t5, and t6 have the same value. In some other examples, one or more of the switching durations t1, t2, t3, t4, t5, or t6 may have a different value than the other switching durations. In one such example, each switching duration t1, t2, t3, t4, t5, and t6 may have a different value. In some other examples, some switching durations may be immediate, while other switching durations may have a non-zero value. For example, the switching duration t1 from the passive backscatter mode to the amplified backscatter mode may be an immediate switch. Additionally, in this example, both the switching duration t6 from the passive backscatter mode to the active transmission mode, and the switching duration t4 from the amplified backscatter mode to the active transmission mode may have non-zero values, such that the switching duration t6 and the switching duration t4 are not immediate switches.

In some examples, a condition to trigger a switch from one ambient transmission mode to another ambient transmission mode may depend on an energy status. The condition to trigger the switch may also be referred to as a switching factor. The ambient IoT device may be associated with a group of switching factors. The group of switching factors may be indicated, to a network node, via the one or more ambient transmission parameters included in a capability report. Each switching factor may be associated with a respective switch from one ambient transmission mode to another ambient transmission mode. That is, the ambient IoT device may switch from one ambient transmission mode to another ambient transmission mode, in accordance with the respective switching factor, from the group of switching factors, that was triggered. In some examples, a first switching factor may be triggered when the energy status is less than a first threshold. In such examples, a second switching factor may be triggered when the energy status is greater than a second threshold. The first threshold may be the same as, or different than, the second threshold. The ambient IoT device may indicate, to a network node, the group of switching factors via the one or more ambient transmission parameters included in a capability report. Additionally, or alternatively, a switch from one ambient transmission mode to another ambient transmission mode may be triggered based on a message (for example, an indication) received from a network node. For example, the switching factor for a switch from the passive backscatter mode to the amplified backscatter mode, and vice versa, may be based on an energy status. In such an example, the switching factor from one of the backscatter-based ambient transmission modes to the active transmission mode, and vice versa, may be based on an indication from the network node.

In some examples, the capability report may indicate whether the ambient IoT device supports a continuous transmission mode or a discontinuous transmission mode. In some examples, in the discontinuous transmission mode, the ambient IoT device transmits data for a period of time and then returns to a non-transmission mode. A sleep mode is an example of a non-transmission mode. In some examples, the ambient IoT device may harvest energy (for example, enter a charging mode) during the non-transmission mode. The ambient IoT device may repeat the transmission and non-transmission cycle periodically, depending on one or more factors, such as available energy and specified transmission periodicity. If the discontinuous transmission mode is supported, the capability report may indicate the transmission period (for example, traffic duration) and the non-transmission period (for example, charging duration). In the continuous transmission mode, the ambient IoT device does not transition between transmission and non-transmission modes.

In some examples, the one or more ambient transmission parameters included in the capability report may indicate one or more supported modulation formats. The supported modulation formats may include one or more of ASK/PSK-based modulation, frequency shift keying (FSK)-based modulation, in-phase and quadrature (IQ)-based modulation, OFDM-based modulation, or another modulation format. In some examples, to improve energy use, the one or more ambient transmission parameters may indicate one or more factors for enabling OFDM-based modulation and also indicate a lowest energy threshold (for example, X millijoules (mJ)) for the OFDM-based modulation. In some such examples, if an energy level falls below the lowest energy threshold supported by the OFDM-based modulation, the ambient IoT device may switch to the ASK/PSK-based modulation or enter a sleep mode. Alternatively, the one or more ambient transmission parameters may indicate a percentage of energy storage remaining. In such examples, if the percentage of energy storage is less than an energy storage threshold, the ambient IoT device may switch to ASK/PSK-based modulation or enter the sleep mode.

In some examples, each ambient transmission mode may support one or more modulation formats. The one or more ambient transmission parameters may indicate the one or more modulation formats supported by each ambient transmission mode. For example, the ambient IoT device may support both the passive backscatter mode and the active transmission mode. In one example, the one or more ambient transmission parameters may indicate the passive backscatter mode only supports ASK-based modulation. In contrast, in this example, the active transmission mode may support both ASK-based modulation and IQ-based modulation.

In some examples, the one or more ambient transmission parameters included in the capability report may indicate whether the ambient IoT device has a local clock. If the ambient IoT device has a local clock, the one or more ambient transmission parameters may also indicate a capability of a local oscillator (for example, local clock). In some examples, the local oscillator may generate a fixed frequency. In some other examples, the local oscillator may generate different frequencies. The different frequencies and/or the fixed frequency may be indicated via the one or more ambient transmission parameters. In some such examples, the local oscillator may generate a set of discrete frequencies. In other such examples, the local oscillator may generate a range of frequencies. In such examples, the one or more ambient transmission parameters may indicate a tuning step size supported by the local oscillator. The tuning step size refers to an incremental change in frequency t to adjust the frequency output by the local oscillator. In some examples, the one or more ambient transmission parameters may indicate a reliability of the local oscillator. The reliability may be indicated via one or more parameters, such as local oscillator leakage (for example, frequency drifts based on time and/or temperature), repeatability, or phase noise.

In some examples, the one or more ambient transmission parameters may indicate whether or not the ambient IoT device supports a frequency shift. If the frequency shift is supported, the one or more ambient transmission parameters may further indicate the supported frequency shift range and granularity. The frequency shift granularity refers to a minimum amount by which a frequency of a signal can be shifted or changed.

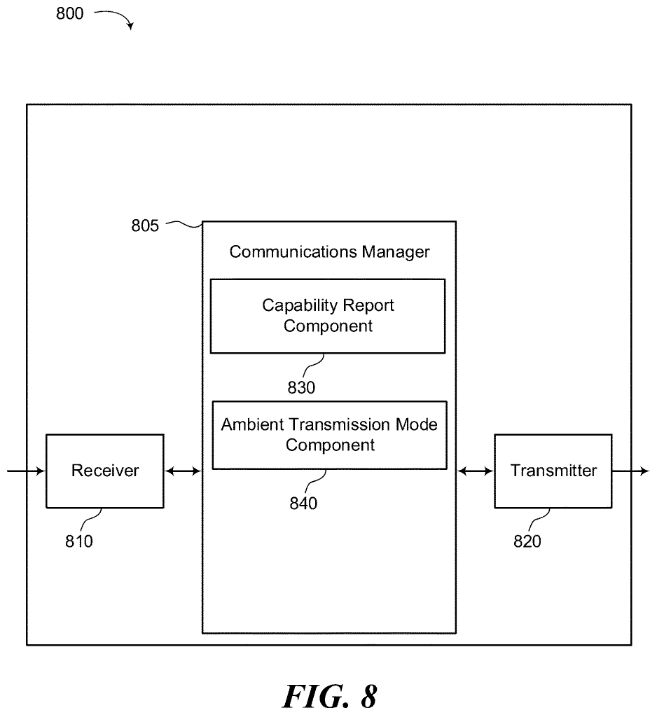

FIG. 8 is a block diagram illustrating an example wireless communication device 800 that supports multiple ambient transmission modes, in accordance with some aspects of the present disclosure. The device 800 may be an example of aspects of a UE 80 described with reference to FIGS. 1, 2, and 3, or an ambient IoT device 402A, 402B, 402C, 402D, or 402E described with reference to FIG. 4. The wireless communication device 800 may include a receiver 810, a communications manager 805, a transmitter 820, a capability report component 830, and an ambient transmission mode component 840 which may be in communication with one another (for example, via one or more buses). In some examples, the wireless communication device 800 is configured to perform operations, including operations of the process 900 described below with reference to FIG. 9.

In some examples, the wireless communication device 800 can include a chip, chipset, package, or device that includes at least one processor and at least one modem (for example, a 5G modem or other cellular modem). In some examples, the communications manager 805, or its sub-components, may be separate and distinct components. In some examples, at least some components of the communications manager 805 are implemented at least in part as software stored in a memory. For example, portions of one or more of the components of the communications manager 805 can be implemented as non-transitory code executable by the processor to perform the functions or operations of the respective component.

The receiver 810 may receive one or more of reference signals (for example, periodically configured channel state information reference signals (CSI-RSs), aperiodically configured CSI-RSs, or multi-beam-specific reference signals), synchronization signals (for example, synchronization signal blocks (SSBs)), control information and data information, such as in the form of packets, from one or more other wireless communication devices via various channels including control channels (for example, a physical downlink control channel (PDCCH), physical uplink control channel (PUCCH), or physical sidelink control channel (PSCCH) and data channels (for example, a physical downlink shared channel (PDSCH), physical sidelink shared channel (PSSCH), a physical uplink shared channel (PUSCH)). The other wireless communication devices may include, but are not limited to, a base station 110 or UE 120 as described with reference to FIGS. 1 and 2, a CU 310, DU 330, or RU 340 as described with reference to FIG. 3, or a network node 420 as described with reference to FIG. 4.

The received information may be passed on to other components of the device 800. The receiver 810 may be an example of aspects of the receive processor 258 described with reference to FIG. 2. The receiver 810 may include a set of radio frequency (RF) chains that are coupled with or otherwise utilize a set of antennas (for example, the set of antennas may be an example of aspects of the antennas 252 described with reference to FIG. 2).

The transmitter 820 may transmit signals generated by the communications manager 805 or other components of the wireless communication device 800. In some examples, the transmitter 820 may be collocated with the receiver 810 in a transceiver. The transmitter 820 may be an example of aspects of the transmit processor 264 described with reference to FIG. 2. The transmitter 820 may be coupled with or otherwise utilize a set of antennas (for example, the set of antennas may be an example of aspects of the antennas 252 described with reference to FIG. 2), which may be antenna elements shared with the receiver 810. In some examples, the transmitter 820 is configured to transmit control information in a PUCCH, PSCCH, or PDCCH and data in a physical uplink shared channel (PUSCH), PSSCH, or PDSCH.

The communications manager 805 may be an example of aspects of the controller/processor 259 described with reference to FIG. 2. The communications manager 805 may include the capability report component 830 and the ambient transmission mode component 840. Working in conjunction with the transmitter 820, the capability report component 830 may transmit, to the network node, a capability report indicating a group of ambient transmission modes supported by the wireless communication device and one or more ambient transmission parameters. Working in conjunction with the capability report component 830, the transmission mode component 840 switches from a current ambient transmission mode, of the group of ambient transmission modes, to a second ambient transmission mode, of the group of ambient transmission modes, based on satisfying a first switching condition of a group of switching conditions associated with switching from the current ambient transmission mode to the second ambient transmission mode. Working in conjunction with one or both of the capability report component 830 or the ambient transmission mode component 840, the transmitter 820 and/or the receiver 810 communicates with the network node according to the second ambient transmission mode in accordance with switching to the second ambient transmission mode.

FIG. 9 is a flow diagram illustrating an example process performed, for example, by a user equipment (UE), in accordance with various aspects of the present disclosure. The example process 900 is an example of indicating a capability of a wireless communication device, such as an ambient IoT device, to a network node. The process 900 begins at block 902 by transmitting, to the network node, a capability report indicating a group of ambient transmission modes supported by the wireless communication device and one or more ambient transmission parameters. At block 904, the process 900 switches from a current ambient transmission mode, of the group of ambient transmission modes, to a second ambient transmission mode, of the group of ambient transmission modes, based on satisfying a first switching condition of a group of switching conditions associated with switching from the current ambient transmission mode to the second ambient transmission mode. At block 906, the process 900 communicates with the network node according to the second ambient transmission mode in accordance with switching to the second ambient transmission mode.

Implementation examples are described in the following numbered clauses:

Clause 1. A method for wireless communication by a wireless communication device, comprising: transmitting, to a network node, a capability report indicating a group of ambient transmission modes supported by the wireless communication device and one or more ambient transmission parameters; switching from a current ambient transmission mode, of the group of ambient transmission modes, to a second ambient transmission mode, of the group of ambient transmission modes, based on satisfying a first switching condition of a group of switching conditions associated with switching from the current ambient transmission mode to the second ambient transmission mode; and communicating with the network node according to the second ambient transmission mode in accordance with switching to the second ambient transmission mode.

Clause 2. The method of Clause 1, wherein the one or more ambient transmission parameters include one or more of a group of switching durations, a group of switching factors, a continuous transmission parameter indicating whether the wireless communication device supports continuous transmissions or discontinuous transmissions, one or more supported modulation formats, a local clock parameter indicating whether the wireless communication device includes a local clock, or a frequency shift parameter indicating whether the wireless communication device supports a frequency shift.

Clause 3. The method of Clause 2, wherein: each switching duration of the group of switching durations is associated with a respective duration for switching from one ambient transmission mode, of the group of ambient transmission modes, to another ambient transmission mode, of the group of ambient transmission modes; and each switching condition of the group of switching conditions is associated with a respective condition for switching from one ambient transmission mode, of the group of ambient transmission modes, to another ambient transmission mode, of the group of ambient transmission modes.

Clause 4. The method of any one of Clauses 2-3, wherein each ambient transmission mode of the group of ambient transmission modes is associated with a respective supported modulation format of the one or more supported modulation formats.

Clause 5. The method of any one of Clauses 2-4, wherein the one or more ambient transmission parameters further include, based on the wireless communication device including the local clock, an indication of a frequency generation capability of an oscillator associated with the wireless communication device and one or more of phase noise, repeatability, or leakage associated with the local clock.

Clause 6. The method of any one of Clauses 1-5, wherein the first switching condition is satisfied based on receiving, from the network node, a switching indication, an energy level at the wireless communication device being greater than a first energy threshold, or the energy level at the wireless communication device being less than a second energy threshold.

Clause 7. The method of any one of Clauses 1-6, wherein the group of ambient transmission modes includes two or more of an active transmission mode, a passive backscatter mode, or an amplified backscatter mode.

Clause 8. The method of Clause 7, wherein: the active transmission mode is associated with a maximum transmission power value from a group of transmission power values supported by the wireless communication device; and each transmission power value of the group of transmission power values is associated with an energy level and a time period for transmitting at the respective transmission power value.

Clause 9. The method of any one of Clauses 7-8, wherein the amplified backscatter mode is associated with a fixed power amplification value or a range of power amplification values.

Clause 10. The method of any one of Clauses 1-9, wherein: the wireless communication device is an ambient IoT device; and the network node is a UE, a base station, an IAB node, or an IAB repeater.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (for example related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

1. A method for wireless communication by a wireless communication device, comprising:
transmitting, to a network node, a capability report indicating a group of ambient transmission modes supported by the wireless communication device and one or more ambient transmission parameters;
switching from a current ambient transmission mode, of the group of ambient transmission modes, to a second ambient transmission mode, of the group of ambient transmission modes, based on satisfying a first switching condition of a group of switching conditions associated with switching from the current ambient transmission mode to the second ambient transmission mode; and
communicating with the network node according to the second ambient transmission mode in accordance with switching to the second ambient transmission mode.

2. The method of claim 1, wherein the one or more ambient transmission parameters include one or more of a group of switching durations, a group of switching factors, a continuous transmission parameter indicating whether the wireless communication device supports continuous transmissions or discontinuous transmissions, one or more supported modulation formats, a local clock parameter indicating whether the wireless communication device includes a local clock, or a frequency shift parameter indicating whether the wireless communication device supports a frequency shift.

3. The method of claim 2, wherein:
each switching duration of the group of switching durations is associated with a respective duration for switching from one ambient transmission mode, of the group of ambient transmission modes, to another ambient transmission mode, of the group of ambient transmission modes; and
each switching condition of the group of switching conditions is associated with a respective condition for switching from one ambient transmission mode, of the group of ambient transmission modes, to another ambient transmission mode, of the group of ambient transmission modes.

4. The method of claim 2, wherein each ambient transmission mode of the group of ambient transmission modes is associated with a respective supported modulation format of the one or more supported modulation formats.

5. The method of claim 2, wherein the one or more ambient transmission parameters further include, based on the wireless communication device including the local clock, an indication of a frequency generation capability of an oscillator associated with the wireless communication device and one or more of phase noise, repeatability, or leakage associated with the local clock.

6. The method of claim 1, wherein the first switching condition is satisfied based on receiving, from the network node, a switching indication, an energy level at the wireless communication device being greater than a first energy threshold, or the energy level at the wireless communication device being less than a second energy threshold.

7. The method of claim 1, wherein the group of ambient transmission modes includes two or more of an active transmission mode, a passive backscatter mode, or an amplified backscatter mode.

8. The method of claim 7, wherein:
the active transmission mode is associated with a maximum transmission power value from a group of transmission power values supported by the wireless communication device; and
each transmission power value of the group of transmission power values is associated with an energy level and a time period for transmitting at the respective transmission power value.

9. The method of claim 7, wherein the amplified backscatter mode is associated with a fixed power amplification value or a range of power amplification values.

10. The method of claim 1, wherein:
the wireless communication device is an ambient Internet of things (IoT) device; and
the network node is a user equipment (UE), a base station, an integrated access and backhaul (IAB) node, or an IAB repeater.

11. An apparatus for wireless communication at a wireless communication device, comprising:
a processor; and
a memory coupled with the processor and storing instructions operable, when executed by the processor, to cause the apparatus to:
transmit, to a network node, a capability report indicating a group of ambient transmission modes supported by the wireless communication device and one or more ambient transmission parameters;
switch from a current ambient transmission mode, of the group of ambient transmission modes, to a second ambient transmission mode, of the group of ambient transmission modes, based on satisfying a first switching condition of a group of switching conditions associated with switching from the current ambient transmission mode to the second ambient transmission mode; and
communicate with the network node according to the second ambient transmission mode in accordance with switching to the second ambient transmission mode.

12. The apparatus of claim 11, wherein the one or more ambient transmission parameters include one or more of a group of switching durations, a group of switching factors, a continuous transmission parameter indicating whether the wireless communication device supports continuous transmissions or discontinuous transmissions, one or more supported modulation formats, a local clock parameter indicating whether the wireless communication device includes a local clock, or a frequency shift parameter indicating whether the wireless communication device supports a frequency shift.

13. The apparatus of claim 12, wherein:
each switching duration of the group of switching durations is associated with a respective duration for switching from one ambient transmission mode, of the group of ambient transmission modes, to another ambient transmission mode, of the group of ambient transmission modes; and
each switching condition of the group of switching conditions is associated with a respective condition for switching from one ambient transmission mode, of the group of ambient transmission modes, to another ambient transmission mode, of the group of ambient transmission modes.

14. The apparatus of claim 12, wherein each ambient transmission mode of the group of ambient transmission modes is associated with a respective supported modulation format of the one or more supported modulation formats.

15. The apparatus of claim 12, wherein the one or more ambient transmission parameters further include, based on the wireless communication device including the local clock, an indication of a frequency generation capability of an oscillator associated with the wireless communication device and one or more of phase noise, repeatability, or leakage associated with the local clock.

16. The apparatus of claim 11, wherein the first switching condition is satisfied based on receiving, from the network node, a switching indication, an energy level at the wireless communication device being greater than a first energy threshold, or the energy level at the wireless communication device being less than a second energy threshold.

17. The apparatus of claim 11, wherein the group of ambient transmission modes includes two or more of an active transmission mode, a passive backscatter mode, or an amplified backscatter mode.

18. The apparatus of claim 17, wherein:
the active transmission mode is associated with a maximum transmission power value from a group of transmission power values supported by the wireless communication device; and
each transmission power value of the group of transmission power values is associated with an energy level and a time period for transmitting at the respective transmission power value.

19. The apparatus of claim 17, wherein the amplified backscatter mode is associated with a fixed power amplification value or a range of power amplification values.

20. The apparatus of claim 11, wherein:
the wireless communication device is an ambient Internet of things (IoT) device; and
the network node is a user equipment (UE), a base station, an integrated access and backhaul (IAB) node, or an IAB repeater.

21-30. (canceled)
